(19) United States
(12) Patent Application Publication
(10) Pub. No.: US 2026/0090661 A1
(43) Pub. Date: Apr. 2, 2026

(54) SYSTEMS AND METHODS FOR PROTECTING RETAIL DISPLAY MERCHANDISE FROM THEFT

(71) Applicant: InVue Security Products Inc., Charlotte, NC (US)

(72) Inventor: Jonathon D. Phillips, Fort Mill, SC (US)

(21) Appl. No.: 19/345,630

(22) Filed: Sep. 30, 2025

Related U.S. Application Data
(60) Provisional application No. 63/701,634, filed on Oct. 1, 2024.

(51) Int. Cl. A47F 7/024; G08B 13/14

(52) U.S. Cl. CPC A47F 7/024; G08B 13/14

(57) ABSTRACT

Security systems and methods for protecting retail display merchandise from theft are provided. For example, a security system includes a plurality of sensors, each sensor configured to be secured to an item of merchandise. The security system also includes a monitoring system configured to wirelessly communicate with each of the plurality of sensors, wherein the monitoring system and the plurality of sensors are configured to communicate signals with one another to determine a location of each sensor based on an angle of arrival of the signals. The monitoring system and/or at least one of the plurality of sensors is configured to initiate a security signal based on the location of each sensor.

### CROSS REFERENCE TO RELATED APPLICATIONS

This application claims benefit of priority to U.S. Provisional Application No. 63/701,634, filed on Oct. 1, 2024, the entire disclosure of which is incorporated herein by reference.

### FIELD OF THE INVENTION

Embodiments of the present invention relate generally to merchandise security, and, more particularly, to systems and methods for protecting retail display merchandise from theft.

### BACKGROUND OF THE INVENTION

Displays for retail merchandise utilize different types of theft deterrent security systems and methods to discourage shoplifters. Many of these systems and methods include sensors and alarms that are mechanically attached, or sensors and alarms that are mechanically attached and electrically connected, to the item of merchandise to be protected. When the integrity of the display is compromised, such as by cutting or removing a cable that extends between the security system and the item of merchandise, or by separating the item of merchandise from the security system, an alarm is activated to alert store personnel of a potential theft situation. Thus, conventional security systems having mechanical or electro-mechanical cables tethered to an item of merchandise, and other security systems that are physically attached to an item of merchandise, provide visual security at the expense of restricting a potential purchaser's ability to interact freely with the merchandise. Consequently, conventional systems that provide visual security suffer from the disadvantage of providing a reduced “customer experience” for a potential purchaser of the merchandise. Moreover, some security systems use wireless security in their high experience stores, but they have problems with false alarms and a high cost per position.

### BRIEF SUMMARY

In one embodiment of the invention, a security system for securing an item of merchandise from theft is provided. The security system includes a plurality of sensors, each sensor configured to be secured to an item of merchandise. The security system also includes a monitoring system configured to wirelessly communicate with each of the plurality of sensors, wherein the monitoring system and the plurality of sensors are configured to communicate signals with one another to determine a location of each sensor based on an angle of arrival of the signals. The monitoring system and/or at least one of the plurality of sensors is configured to initiate a security signal based on the location of each sensor.

In another embodiment, a method for securing an item of merchandise from theft is provided. The method includes wirelessly communicating signals between a monitoring system and a plurality of sensors, each sensor being secured to an item of merchandise. The method further includes determining a location of each sensor based on an angle of arrival of the signals and initiating a security signal at the monitoring system and/or at least one of the sensors based on the location of each sensor.

### BRIEF DESCRIPTION OF THE DRAWINGS

FIG. 1 is a perspective view of a security system according to one embodiment.

FIG. 2 is another perspective view of the security system shown in FIG. 1.

FIG. 3 is another perspective view of the security system of FIG. 1 showing a sensor lifted off of a base according to one embodiment.

FIG. 4 is a schematic of a monitoring device and a plurality of sensors located within a retail establishment according to one embodiment.

FIG. 5 is another schematic showing a plurality of monitoring devices and associated sensors located within a retail establishment according to one embodiment.

FIG. 6 is another schematic showing a plurality of monitoring devices and associated sensors located within a retail establishment according to one embodiment.

FIG. 7 is yet another schematic showing a plurality of monitoring devices and associated sensors located within a retail establishment according to one embodiment.

FIG. 8 illustrates a monitoring device located near a door or exit and configured to detect when a sensor is within a predefined proximity range relative to the monitoring device according to one embodiment.

FIG. 9 is a schematic of a monitoring device located near a door or an exit and a plurality of sensors located within a retail establishment according to one embodiment.

FIGS. 10-12 are schematics of a combination of inclusion zones and exclusion zones utilizing a plurality of monitoring devices and sensors according to various embodiments.

FIGS. 13-16 illustrate schematics of alarm zones that may be created based on communication between a plurality of sensors and a monitoring system in a retail environment according to various embodiments.

FIGS. 17-20 show a monitoring system in communication with one or more sensors according to various embodiments.

FIG. 21 is a schematic showing the signals communicated between a monitoring system and one or more sensors using angle of arrival according to one embodiment.

FIG. 22 shows a diagram of a monitoring system in communication with a sensor according to one embodiment.

### DETAILED DESCRIPTION OF THE INVENTION

The present invention will now be described more fully hereinafter with reference to the accompanying drawings, in which various embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation and multiple prime notations are used to indicate similar elements in alternative embodiments.

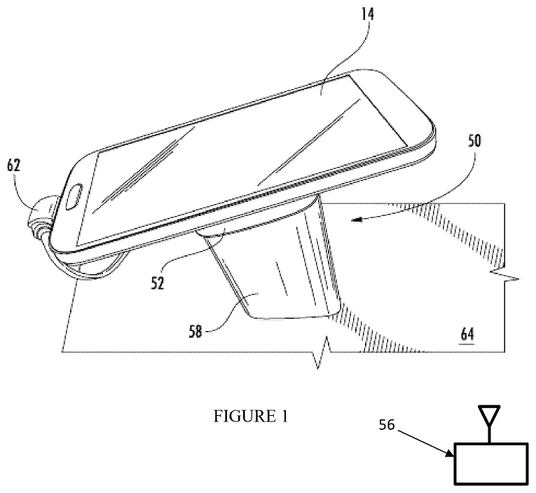

FIG. 1 illustrates one embodiment of a security system 50 configured to secure an item of merchandise or any consumer product from theft in a retail display. The security system may generally include a sensor 52 configured to be coupled to an item of merchandise 14, and a monitoring device 56 (sometimes referred to a table manager or door manager) configured to wirelessly communicate with the sensor and/or the item of merchandise. The security system 50 may further include a base 58 or display stand for supporting the sensor 52 and the item of merchandise 14. The monitoring device 56 and the sensor 52 may be configured to communicate with one another to determine the proximity of the item of merchandise 14 relative to the monitoring device. Moreover, the monitoring device 56 may be configured to determine a proximity range between the sensor 12 and the monitoring device, wherein the proximity range may be indicative of the strength of communication or distance between the sensor and the monitoring device. The monitoring device 56 may be configured to generate a security signal based on the proximity between the monitoring device 56 and the sensor 52.

The item of merchandise 14 may be any portable electronic device, such as a mobile or cellular phone, a Smartphone, a tablet, notebook, laptop computer, virtual headset, or the like. One advantage of the security system 50 is that the item of merchandise 14 is not required to be mechanically tethered to a base, support or the like. Thus, a consumer is free to examine the item of merchandise 14 without any physical restraints. As will be explained in further detail below, the monitoring device 56 may be configured to communicate with the sensor 52 and/or the item of merchandise 14 to establish a “wireless tether,” such that although physical security is not provided, wireless security is provided. As a result, the security system 50 provides for an improved or increased “customer experience,” and thereby increases the likelihood of the customer purchasing the item of merchandise 14, while reducing the possibility of theft of the merchandise. In particular, mechanical and electromechanical tethered security devices that include cords, cables, etc. may interfere with the customer experience by restricting the ability of the potential purchaser to freely interact with the item of merchandise. Furthermore, although the security system 50 is described herein in relation to a merchandise display in a retail store, it is understood that a security system 50 according to the invention is applicable to any number of environments, such as in hospitals, restaurants, etc.

The sensor 52 of the security system 50 is configured to be engaged with and disengaged from the item of merchandise 14. As such, the sensor 52 may be removably engaged with the item of merchandise 14, for example, by being inserted within an input port of the item of merchandise. As such, the sensor 12 may include a connector 62 configured for engaging an input port provided on the item of merchandise 14. By way of example and not limitation, the input port could be a standard input port provided on the item of merchandise 14, such as a USB port, micro-USB port, USB-C port, or the like. The input port may be the same port used for power and/or data transfer with the item of merchandise. In some embodiments, the sensor 52 and the item of merchandise 14 are in electrical communication with one another when the sensor is engaged with the input port of the item of merchandise. In other embodiments, the sensor 52 may include a proximity mechanism (e.g., a pressure or plunger switch) that is configured to detect when the sensor is not engaged with the input port of the item of merchandise 14, for example, when the sensor has been removed from the item of merchandise, and/or to detect removal of the sensor from the back of the item of merchandise. Although shown as being separate components, it is understood that the sensor 52 could be integrated into the item of merchandise 14 so that the sensor is not required to be engaged with the input port. As such, the sensor 52 may be integrated with or coupled to the item of merchandise 14.

In one embodiment, the sensor 52 is configured to receive power from the item of merchandise 14. For example, the item of merchandise 14 may include a battery that is configured to transfer power to the sensor 52 when the sensor is operably engaged with the merchandise and lifted off of the base 58. As such, the sensor 52 does not require its own power source for operation. In another example, the sensor 52 and item of merchandise 14 may communicate using USB power delivery whereby the sensor 52 is configured to automatically switch between sourcing and receiving states. Thus, when the sensor 52 is seated on the base 58, power may be delivered to the sensor and the item of merchandise, and when the sensor is lifted off of the base, the sensor automatically receives power from the item of merchandise. In this example, the sensor 52 and item of merchandise may be connected via a USB-C connector 62.

In some embodiments, the sensor 52 comprises a power source, such as a battery. In this case, the sensor 52 may be operable for detecting when it is removed from the item of merchandise 14. For example, the sensor 52 may establish a sense loop between the sensor and the item of merchandise 14, such that when the sensor is removed, the sense loop is interrupted. The sensor 52 may then be configured to communicate with the monitoring device 56 and/or the item of merchandise 14 to initiate or otherwise generate a security signal.

The sensor 52 may include communications circuitry for communicating with the monitoring device 56. For example, the communications circuitry of the sensor 12 may be configured to wirelessly communicate with the monitoring device 56 using any desired communications protocol such as, for example, Bluetooth wireless communication, Bluetooth Low Energy (“BLE”) wireless communication, WiFi wireless communication, cellular wireless communication, received signal strength indicator (“RSSI”), ultra-wideband (UWB) time of flight, and/or ambient backscatter. Similarly, the monitoring device 56 may include complementary communications circuitry for communicating with the sensor 52. In one embodiment, the wireless communications circuitry carried by the sensor 52 and/or the monitoring device 56 may include, for example, one or more wireless transceivers for transmitting and receiving wireless communications.

The monitoring device 56, sometimes referred to as a “table manager” or “door manager”, may be configured to communicate wirelessly with one or more sensors 52 and/or the items of merchandise 14. The monitoring device 56 may include a battery, which may be used for back-up power should power provided from an external power source be lost. Furthermore, the monitoring device 56 may be secured to a merchandise display surface 64, such as a display counter, table, shelf, fixture, wall, or the like using any suitable technique such as adhesives and/or fasteners. It is understood that the sensor 52 could function as a table manager or door manager and communicate with the monitoring device 16 in a similar manner. Thus, the functionality of the sensor 52 and the monitoring device 56 could be reversed if desired. Furthermore, both the sensor 52 and the monitoring device 56 could be configured to function as a table manager or door manager. For example, both the sensor 52 and the monitoring device 56 may be configured to collect data (e.g., UWB data) and communicate with one another to determine a position of the item of merchandise 14 relative to the sensor and/or the monitoring device.

In some embodiments, the monitoring device 56 includes a controller and wireless communications circuitry coupled to the controller. The monitoring device 56 may be paired, for example, by wireless communication (e.g. Bluetooth, BLE, RF, IR, etc.), with one or more sensors 52 and/or the items of merchandise 14. As such, the sensor 52 and/or the item of merchandise 14 is configured to communicate, via its respective wireless communications circuitry, with the monitoring device 56 via its wireless communications circuitry. In other words, the sensor 52 and/or the item of merchandise 14 may be paired with a monitoring device 56 by way of wireless communications.

As previously mentioned, in some embodiments the monitoring device 56 may be conceptually thought of as a “table manager” or “door manager”. As explained in further detail below, if the strength of communication between the monitoring device 56 and the sensor 52 decreases or increases, communication has been lost, or time-of-flight changes, the monitoring device may generate a security signal with the alarm module that is indicative of an unsecured state or condition, for example, an audio, visual, and/or haptic alarm. The monitoring device 56 may also communicate, via the wireless communications circuitry, to the sensor 52 to activate a respective output device of the sensor and/or the item of merchandise 14 (i.e., a dual alarm condition) so that security personnel are able to identify the sensor of a particular item of merchandise communicating a security signal.

The monitoring device 56 and/or the base 58 may include an alarm that will generate a security signal, such as an audible and/or visual alarm. The monitoring device 56 and/or the base 58 may include an alarm for generating a security signal in response to various security events (e.g., unplugging/cutting a cable, disconnecting the monitoring device 56, disconnecting the sensor 52, etc.). For example, the monitoring device 56 and/or the base 58 may include a piezoelectric alarm to generate an audible alarm signal. The monitoring device 56 and/or the base 58 could also be configured to generate a visible alarm signal, or provide other visible indicators (e.g., armed or alarming), such as with a light-emitting diode (“LED”).

Various techniques for transferring power to the sensor 52 and/or the item of merchandise 14 may be employed, such as capacitive contact charging, inductive charging, or wired charging. In one example, the base 58 and the item of merchandise 14 have wireless “qi” compliant battery charging capability that incorporate magnetic inductive coils to transfer electrical power from the base to the item of merchandise in a known manner. The sensor 52 may be configured to transmit power from an external power source to the item of merchandise 14, such as power provided from the base 58. For instance, the sensor 12 may simply pass power from the base 58 through to the item of merchandise 14 for charging the battery of the item of merchandise.

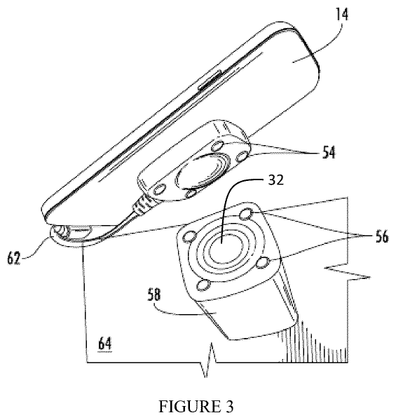

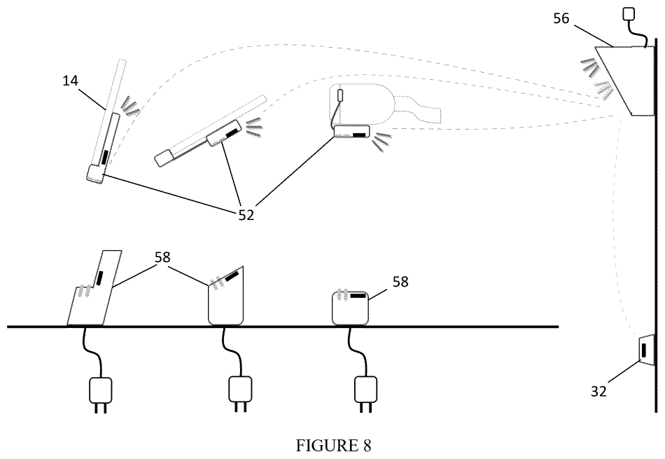

In some embodiments, the sensor 52, monitoring device 56, and/or the base 58 can be armed, disarmed, and/or silenced with a security key, which may utilize mechanical, wireless, and/or electrical communication between the component(s) of the security system 50 and the security key. For example, the security key may be configured to wirelessly communicate a security code to the sensor 52 and/or the monitoring device 56, such as by infrared (“IR”), optical, acoustic, or inductive communication. For example, the sensor 52, monitoring device 56, and/or the base 58 may include a port 32, window, or the like (e.g., FIG. 3), or be in communication with such a port (see, e.g., FIG. 8), that is configured to transmit and/or receive wireless signals from the security key. In one particular embodiment, the security key is similar to that disclosed in U.S. Pat. No. 7,737,845, entitled Programmable Key for a Security System for Protecting Merchandise, the entire disclosure of which is incorporated herein by reference. In additional embodiments, the sensor 52, monitoring device 56, and/or the base 58 may include near field communication (“NFC”) functionality and may be configured to communicate with a security key or other device having NFC functionality for arming and disarming the alarm of the alarm module. Alternatively, the sensor 52, monitoring device 56, and/or the base 58 may include “screen swipe” functionality and/or be configured to sense particular movement or motion to be armed and/or disarmed. Likewise, the sensor 52, monitoring device 56, and/or the base 58 may include biometric functionality for recognizing a particular user for arming and/or disarming an alarm.

The security key may communicate wirelessly to arm and/or disarm an alarm provided on either the sensor 52 or the monitoring device 56, or both. The security key may arm and/or disarm arm the sensor 52 and/or monitoring device 56 independently or in cooperation with one another. For example, disarming the sensor 52 with a security key may also disarm the monitoring device 56. However, the security key may be required to silence or disarm each of the sensor 52 and the monitoring device 56 in some instances. If desired, the base 58 may also include a proximity mechanism (e.g., a pressure or plunger switch) that is operable for detecting if the base has been removed from a fixture, support, display surface 64, or the like, and a piezoelectric alarm for generating a security signal when the base has been tampered with or removed.

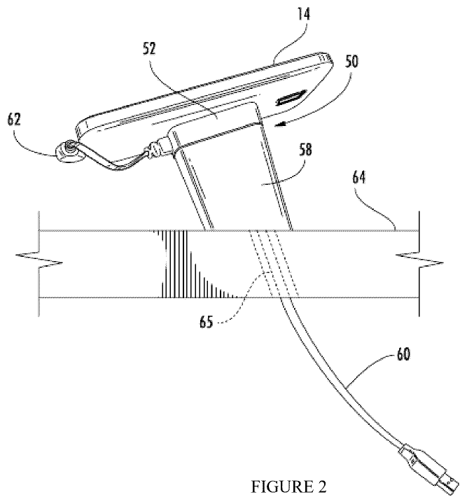

FIGS. 1-3 show an embodiment of a security system 50 in which the sensor 52 comprises one or more contacts 54 that are configured to align with one more contacts 56 on a base 58. When the contacts 54, 56 are in physical contact with one another, electrical power is able to be transmitted to the sensor 52 and the item of merchandise 14. When the sensor 12 is lifted off of the base 58, electrical power is no longer transmitted to the sensor 52 of the item of merchandise 14. A power cable 60 configured to be electrically connected to a power source may be electrically connected to the base 58. Thus, the item of merchandise 14 may be charged when the contacts 54, 56 are electrically connected with one another. In this embodiment, a power adaptor cable and connector 62 may be configured to be electrically connected to an input port of the item of merchandise 14 at one end and to the sensor 52 at the other end. The connector 62 may be removably inserted within the input port of the item of merchandise 14, and should the connector 62 be removed in an unauthorized manner, the monitoring device 56 and/or sensor 52 may be configured to detect the removal and initiate or otherwise generate a security signal. In this embodiment, the sensor 52 may be attached to the rear of the item of merchandise 14, for example, by a pressure-sensitive adhesive. Furthermore, different power adapter cables having different connectors may be used for various items of merchandise that use different input ports. In some cases, the item of merchandise 14 and the sensor 52 may be removably supported on the base 58 as shown in FIG. 1. Moreover, the base 58 may be configured to be mounted to a support, fixture, or the like, such as a display surface 64, whereby the power cable 60 may extend through an opening 65, as shown in FIG. 2.

As previously described, the wireless communications may be utilized to initially identify the sensor for pairing the sensor 52 to a particular monitoring device 56. The pairing may include, for instance, associating a specific identifier of the monitoring device 56 and/or the sensor 52 with one another. In some embodiments, once a sensor 52 is paired with a specific monitoring device 56, the sensor cannot be paired with another monitoring device 56 without first disarming the sensor and/or the monitoring device 56. Should a sensor 52 be placed on a wrong base 58, the sensor and/or monitoring device 56 may be configured to generate an audible and/or visible signal to indicate that the sensor has been placed on the wrong base.

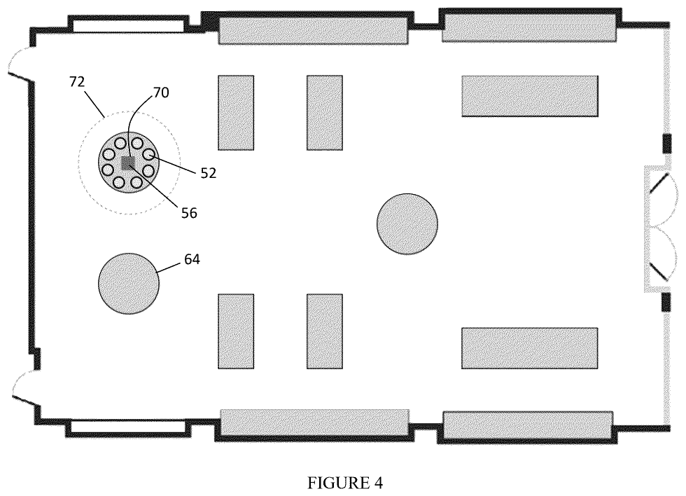

As discussed above, the monitoring device 58 and one or more sensors 52 may be configured to wirelessly communicate with one another. In some embodiments, the signal strength of communication between the monitoring device 58 and the corresponding sensor(s) 52 may be used to provide security (e.g., via RSSI), or ultra-wideband (UWB) “time-of-flight” communication may be used. For example, a consumer may be permitted to examine an item of merchandise 14 within a predetermined distance from a “home” position (see, e.g., FIG. 4, reference character 70), which may also be the location of the monitoring device 56. As noted above, the home position 70 may correspond to a position where there is no motion of the item of merchandise 14 and the sensor 52 for at least a predetermined time, and/or where an item of merchandise is being charged. Should the signal weaken, strengthen, or cease, or time of communication between the sensor 52 and monitoring device increase, decrease, or cease, a security signal may be generated by the sensor and/or monitoring device. In some embodiments, the communication between the monitoring device 56 and the sensor 52 may be initiated when a consumer interacts with the item of merchandise 14. For example, communication may begin when a consumer picks up the item of merchandise 14. The monitoring device 56 may detect when the sensor 52 and the item of merchandise 14 begin moving and/or when charging ceases. Upon the item of merchandise 14 being picked up, the monitoring device 56 may be configured to detect this interaction and thereafter determine a proximity range that is indicative of the communication signal between the sensor 52 and the monitoring device 56. For instance, the determined proximity range may be a range between the home position 70 and a maximum allowable position from the home position. In other embodiments, communication between the sensors 52 and the monitoring device 56 may be continuous.

The determined proximity range could be based on any number of factors, such as the environment, the position of the item of merchandise 14 or the consumer when the merchandise is initially picked up, the size of the consumer's hand, etc. For example, the monitoring device 56 may create a range that is defined by upper and lower bounds or set points that are used to determine whether the consumer, and thus, the item of merchandise 14, is within an acceptable proximity to the monitoring device. The proximity range may be a range between an established home position 70 and a position that would initiate a security signal. The proximity range may be determined dynamically, such that the home position 70 and a maximum position from the home position are determined dynamically and may be unique for each sensor 52. Alternatively, the proximity range may be defined by the retailer and manually input to the security system. The retailer may establish a maximum value of the proximity range to 2 feet, 3 feet, 5 feet, or any desired distance from the home position that is within the field of communications. In some cases, the retailer is able to select a desired range from a plurality of ranges.

In another embodiment, a calibration routine may be used to initially set the proximity range or other predetermined range. In this example, the sensor 52 is configured to communicate with the monitoring device 56 to set a proximity range. In particular, a user may activate a security key, similar to that described above, to communicate with the monitoring device 56 to initiate the calibration routine (e.g., a predetermined number of key button presses). An audible and/or a visible signal may be emitted to indicate the calibration routine has been initiated. Following the security key activation, the user may be provided a predetermined period of time to set the proximity range (e.g., about 30 seconds to 1 minute). In this case, the user may move the sensor 52 to a desired distance from the monitoring device 56 and activate the security key to communicate with the sensor. Communication between the key and the sensor 52 sets a flag in a message to be transmitted to the monitoring device 56 indicating that the proximity range is to be determined. The monitoring device 56 receives the flagged message from the sensor 52 and calculates the distance. Thus, the monitoring device 56 and the sensor 52 may be configured to exchange data and/or messages containing various information. Following the predetermined period of time, the proximity range is set and any movement of the sensor 52 relative to the monitoring device 56 will be based on the proximity range set during the calibration routine. The calibration routine can be repeated for a plurality of sensors 52 associated with a monitoring device 56, or the calibration routine may be performed for one of the sensors 52, and additional sensors are paired with the monitoring device with the same proximity range. Thus, the calibration routine allows for added flexibility in setting the proximity range and provides the user with the ability to dynamically set the proximity range based on his or her own preferences.

In one embodiment, the proximity range may be determined by a signal strength between the monitoring device 56 and the sensor 52, and the monitoring device may be configured to monitor the signal strength therebetween. For instance, the monitoring device 56 may be configured to continuously monitor the signal strength or periodically monitor the signal strength at a predetermined frequency (e.g., 10-100 Hz).

In one embodiment, the sensor 52 and/or the monitoring device 56 may be configured to determine whether the item of merchandise 14 and the sensor are within a determined proximity range, and to initiate the generation of security signals when the proximity range is exceeded, or when the sensor is located within a proximity range. In some cases, the sensor 52 and monitoring device 56 may independently determine its proximity relative to the proximity range. The monitoring device 56 may in turn be configured to generate a security signal when the distance between the monitoring device 56 and the sensor 52 is not within the proximity range or the sensor 52 is within the proximity range. For example, where the item of merchandise has moved beyond a predetermined allowed distance, the monitoring device 56 may be configured to generate a first warning security signal. The sensor 52 and/or the item of merchandise 14 could alternatively or additionally initiate or otherwise generate such a warning signal. The sensor 52 and/or monitoring device 56 may be configured to then determine whether the item of merchandise 14 and the sensor are moved to a position within the determined proximity range, such as the home position 70. Should the item of merchandise 14 not be returned to the home position 70 or to a position within the determined proximity range, the monitoring device 56 may generate a full security alarm signal. Additionally or alternatively, the item of merchandise 14 and/or sensor 52 may be configured to initiate or otherwise generate a full security alarm signal. Should a valid key (e.g., a valid NFC key) be presented to the monitoring device 56 and/or sensor 52, the security alarm signal may be silenced.

In one embodiment, the monitoring device 56 and sensor(s) 52 are paired (e.g., via Bluetooth communication) and remain in wireless communication with one another. The monitoring device 56 and the item of merchandise 14 and/or sensor 52 may be configured to exchange data or “heartbeat” (“HB”) messages at a predetermined frequency or in predetermined increments of time. For example, the data may include, for example, a message indicating that a security signal be generated. The HB messages may include any desired information, such as the identification of the monitoring device 56 or item of merchandise 14, the state of the monitoring device or the item of merchandise (e.g., armed, security breach, alarming, etc.), or a previous signal strength value. The monitoring device 56 may be configured to monitor for data transmitted from the sensor 52 and/or the item of merchandise 14 (i.e., cellular phone) and to determine whether to initiate a security signal. Likewise, the sensor 52 and/or the item of merchandise 14 may be configured to monitor for data transmitted from the monitoring device 56. The monitoring device 56, the sensor 52, and/or the item of merchandise 14 may be configured to monitor for data in predetermined increments of time (e.g., 150 msec). In addition, the proximity of the item of merchandise 14 may be determined relative to the monitoring device 56 based on signal strength between the monitoring device and the sensor 52 and/or the item of merchandise 14. The signal strength may be used to determine the proximity therebetween and be used in conjunction with the exchange of data to secure the item of merchandise 14 from theft. In this example, the monitoring device 56 may be configured to monitor the signal strength with the item of merchandise 14 based on RSSI.

In some embodiments, the monitoring device 56 may be configured to monitor the proximity between the sensor 52 and the monitoring device based on ultra-wideband (UWB) “time-of-flight.” Depending on the message delivered, the signal strength, and/or time-of-flight data, the monitoring device 56 or the sensor 52 and/or the monitoring device 56 can initiate or otherwise generate a security signal. For example, the monitoring device 56 may generate a security signal (e.g., using a piezoelectric alarm or LED). Similarly, the item of merchandise 14 may be configured to act on a message or data delivered by the monitoring device 56 therebetween, such as by generating a warning security signal, an alarming security signal, or a thank you signal. In addition, the sensor 52 may include an output device (e.g., a piezoelectric alarm) for generating a security signal, such as in response to removal of the sensor from the item of merchandise 14 and/or data delivered by the monitoring device 56. In some embodiments, the sensor 52 may initiate a security signal when a security event is detected by the sensor and/or monitoring device 56 and may communicate with an output device for generating the security signal.

In one embodiment, the item of merchandise 14, sensor 52, and/or the monitoring device 56 are configured to be paired with one another. In one example, the sensor 52 and the monitoring device 56 may be paired and configured to communicate with one another. The sensor 52 may be configured to communicate with the item of merchandise 14 using the connection between the sensor and the item of merchandise (e.g., a USB connection). Thus, two-way communication between the sensor 52 and the item of merchandise 14 may occur. In this embodiment, the monitoring device 56 may be configured to be paired with any desired item of merchandise 14, such that pre-programming of the identification of the item of merchandise into the monitoring device is not required. In one example, once the sensor 52 is coupled to the item of merchandise 14, the monitoring device 56 may automatically be paired with the sensor in order to exchange data therebetween. In this embodiment, the monitoring device 56 is configured to filter out other data being transmitted by surrounding sensors 52 and items of merchandise 14 in order to be paired with the desired sensor. Thus, where the monitoring device 56 is capable of detecting a plurality of sensors 52, the monitoring device is able to filter out all other sensors except for the sensors desired to be monitored. In one embodiment, the sensor 52 may be configured to control certain features of the item of merchandise 14, such as, for example, flashing LEDs, generating audible signals, etc. In a further embodiment, the monitoring device 56 may be configured to be simultaneously paired with one or more sensors 52 and the item of merchandise 14. As such, the monitoring device 56 may be configured to communicate directly with the item of merchandise 14 and the sensor 52. For example, the monitoring device 56 could exchange data directly with the item of merchandise 14, such as via text and/or audio messages.

Using any one or combination of the aforementioned techniques, the monitoring device 56 may be configured to determine the proximity of the item of merchandise 14 relative to the monitoring device based upon the distance traveled by the item of merchandise from the home position 70. For example, the monitoring device 56 may determine whether the item of merchandise 14 has been moved more than a predetermined distance in any radial direction from the home position 70 based on the signal strength, time-of-flight, and/or data being communicated between the monitoring device and the item of merchandise and/or the sensor 52. Of course, the threshold proximity may be set to any desired value or values, or alternatively, to another variable, such as distance, time, acceleration, orientation, etc.

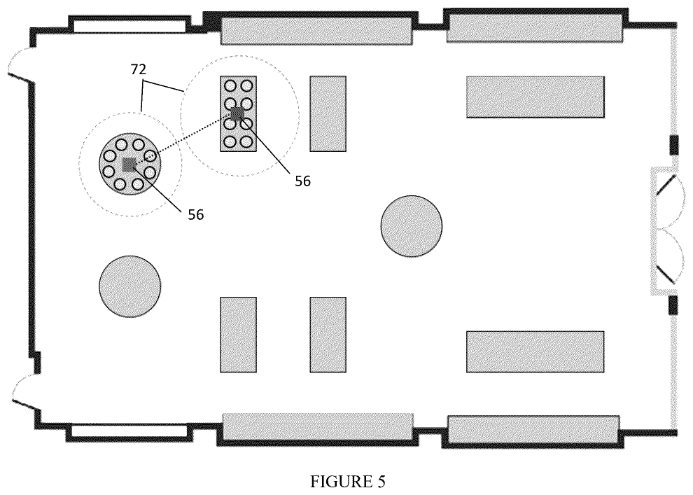

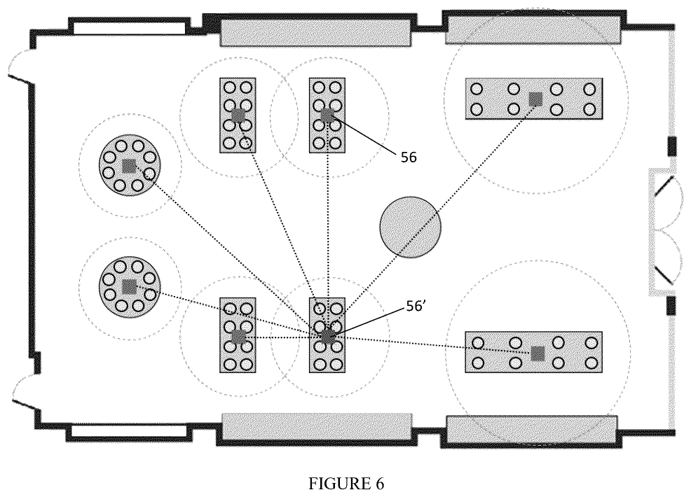

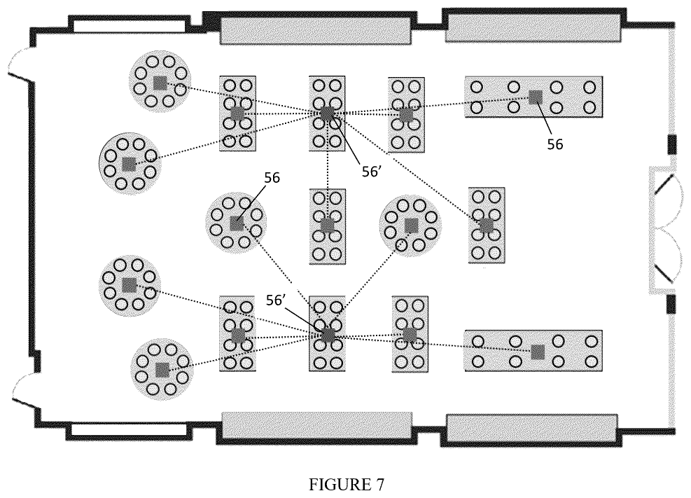

In one embodiment shown in FIG. 4, the monitoring device 56 is located at the home position 70 and is configured to communicate with a plurality of sensors 52. In this example, a plurality of display surfaces 64 are disposed within an establishment, such as a retail store, wherein each display surface may support a plurality of sensors 52 and at least one monitoring device 56. As shown in the dashed line, a proximity range 72 (e.g., a radial range) may be defined relative to the home position 70 (sometimes referred to as an “inclusion zone”), and movement of any one of the sensors 52 outside of the proximity range may result in the sensor and/or the monitoring device generating a security signal. FIG. 5 shows that a plurality of monitoring devices 56 and proximity ranges 72 may be used and that a plurality of monitoring devices may be configured to communicate with one another. For example, at least one monitoring device 56 may be configured to coordinate with other monitoring devices to ensure that communication between the monitoring device and its associated sensors are not impeded by other sensors and monitoring devices, or that sensors from one monitoring device do not communicate with another monitoring device. For instance, at least one monitoring device 56 may utilize multiplexing means to coordinate communication between a plurality of monitoring devices (e.g., via time division multiple access). Moreover, FIG. 6 demonstrates that any number of monitoring devices 56 and sensors 52 may be employed, and that the proximity ranges 72 may overlap in some cases. In this example, one monitoring device 56′ may be configured to coordinate with each of the monitoring devices 56 to ensure that communication between monitoring devices and associated sensors are unaffected. In the embodiment shown in FIG. 7, again a plurality of monitoring devices 56 may be employed, but in this instance, a pair of monitoring devices 56′ may be used for coordinating communication with a plurality of monitoring devices at different frequencies. For instance, each monitoring device 56′ may be configured to operate at different frequencies.

When the threshold proximity has been exceeded, the monitoring device 56 may be configured to generate a security signal, such as a visual, an audible, and/or a haptic alarm. For example, the security signal may be an audible voice message requesting that the item of merchandise 14 be returned to the home position 70 within a specified period of time. The voice message may be customizable in that it may be set to be a male or female voice, and/or may be set to speak in a predetermined language or to speak in one or more of multiple languages. The monitoring device 56 alternatively or additionally may activate other output devices, for example, a haptic (e.g. vibration) device or a visual (e.g. flashing LED) device. The monitoring device 56 may also be configured to communicate with the sensor 52 and/or the item of merchandise 14 to cause the sensor and/or the item of merchandise to initiate or otherwise generate a security signal.

In some embodiments, there may be more than one threshold, for example a first threshold and a second threshold. When the monitoring device 56 determines a first threshold proximity has been exceeded, the monitoring device may initiate an initial “warning” via the sensor 52 and/or the item of merchandise. The warning may be a voice, as noted above, and may indicate for example that unless the item of merchandise 14 is returned to the home position 70 or is brought back within the first threshold proximity, an alarm will be activated. If the item of merchandise 14 is not timely returned to the home position or to a location within the first threshold proximity, and instead, the second threshold proximity is exceeded, the monitoring device 56 may initiate a subsequent alarm, such as an audible siren using the monitoring device, the sensor, and/or the item of merchandise. The subsequent alarm could be greater in volume and/or frequency than the initial alarm. Moreover, the item of merchandise 14 may be configured to generate various security signals as discussed above, such as, for example, a warning message to the consumer that the item of merchandise is secure, a thank-you message to the consumer when a security condition is rectified, an alarming signal, etc. In addition, security signals may be generated in conjunction with any of the aforementioned techniques along with actions that occur in predetermined time increments. For example, the consumer may be allowed a predetermined time period following a warning signal to correct the issue, or a warning signal may be generated when an item of merchandise 14 remains from the home position 70 for longer than a predetermined period of time. Furthermore, visible signals may be generated in response to various conditions, such as a flashing visible signal at the monitoring device 56 and/or the base 58.

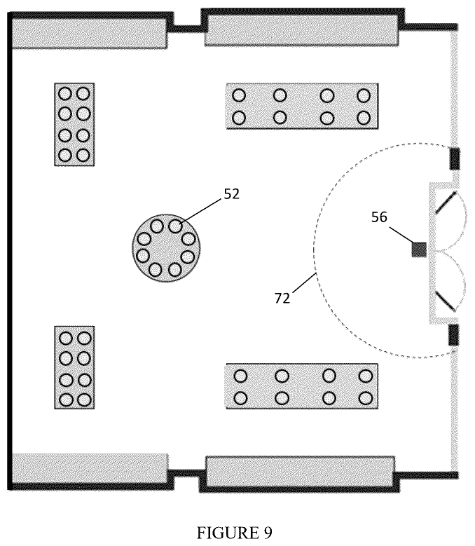

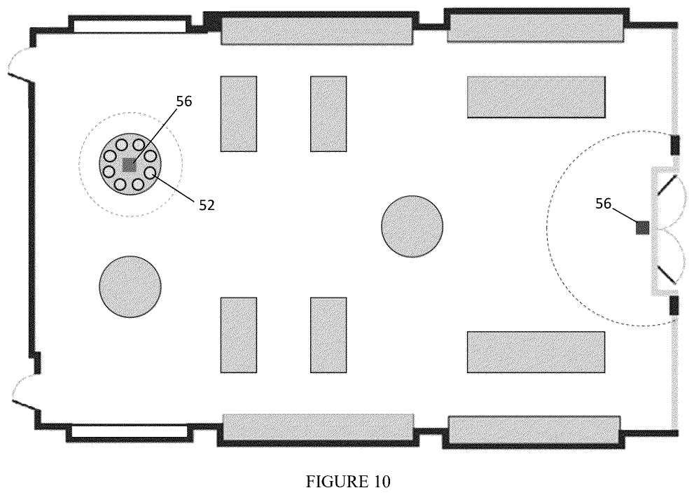

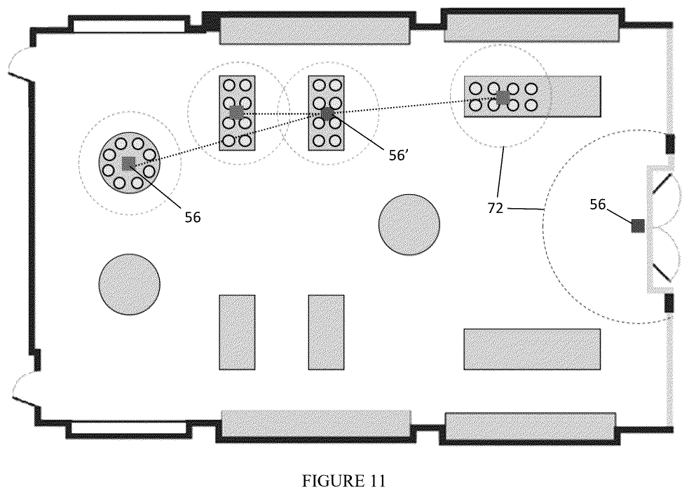

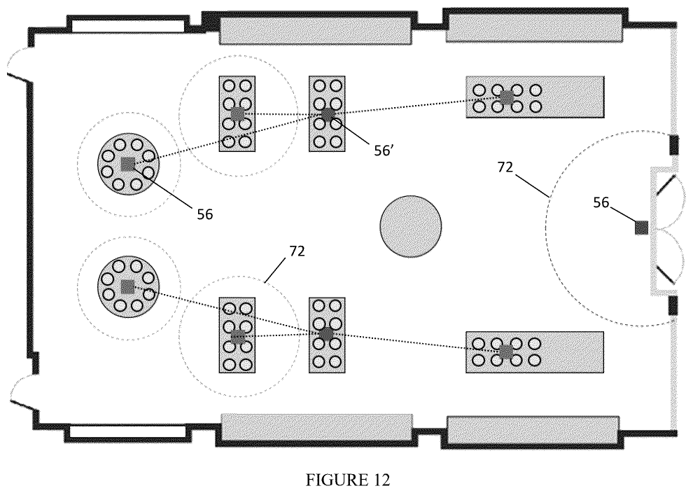

Although some embodiments discussed above relate to detecting a sensor 52 that is no longer within a proximity range 72 (i.e., an inclusion zone), it is understood that the same rationale may be applied to detecting a sensor that is within a proximity range (sometimes referred to as an “exclusion zone”), including the concept of having multiple proximity thresholds. In one embodiment, FIG. 8 shows that a monitoring device 56 (sometimes referred to as a “door manager”) may be located near a door or exit and be configured to detect when a sensor 52 is within a defined proximity range relative to the monitoring device. As before, the monitoring device 56 is configured to communicate with a plurality of sensors 52. FIG. 9 shows an embodiment where a plurality of sensors 52 are employed, and the monitoring device 56 is located near an exit. In one embodiment, a combination of inclusion zones and exclusion zones may be used as shown in FIGS. 10-12. Thus, a monitoring device 56 within an inclusion zone may communicate with a plurality of sensors and generate a security signal if a sensor leaves the inclusion zone, while a monitoring device within an exclusion zone may also be configured to communicate with the sensor and generate a security signal if the sensor enters the exclusion zone. In some cases, the monitoring device 56 within an inclusion zone may be configured to notify a monitoring device within an exclusion zone if a sensor 52 has left the inclusion zone. Likewise, a monitoring device 56 within an exclusion zone may be configured to notify one or more monitoring devices in respective inclusion zones when a sensor 52 leaves the exclusion zone. Moreover, monitoring devices 56 within inclusion zones and/or exclusion zones may communicate with one another to initiate security signals.

Still further, the monitoring device 56 may cooperate with the sensor 52 and/or the item of merchandise 14 to wirelessly transmit instructions to activate another output device, such as a store alarm remote from the item of merchandise and the display area. As will be appreciated by those skilled in the art, the monitoring device 56 may likewise communicate instructions to other security systems and/or devices to perform additional operations. In one example, the monitoring devices 56 may be configured to communicate with one another, such as between monitoring devices within inclusion zones and monitoring devices in exclusion zones.

The monitoring device 56 may be configured to deactivate a security signal upon the item of merchandise 14 being returned within the first or second threshold proximity, for example. Alternatively or additionally, the monitoring device 56 may disable the security signal based upon an input from an input device, for example, a security code entered into the item of merchandise 14, or presenting a key to the sensor 52 and/or the monitoring device. The monitoring device 56 may also deactivate the security signal wirelessly via the wireless communications circuitry, or via a key, such as a mechanical, magnetic, electrical, optical or infrared key fob device. Of course, the monitoring device 56 may perform additional and/or other communications functions upon an alarm condition, as will be appreciated by those skilled in the art including, for example, disabling one or more functions, capabilities, or operations of the item of merchandise.

In another embodiment, the sensor 52 and the monitoring device 56 are paired together in response to the sensor being positioned on or near the monitoring device 56. The monitoring device 56 and the sensor 52 wirelessly communicate between one another with the sensor being removably engaged with an input port provided on the item of merchandise 14. The monitoring device 56 continuously determines the proximity of the sensor 52 and the item of merchandise 14 relative to a home position 70, such as in any manner previously described. The monitoring device 56 may initiate or otherwise generate a first security signal when the proximity between the monitoring device and the sensor 52 is not within (or is within) a predetermined range. Additionally, or alternatively, the monitoring device 56 may initiate or otherwise generate a second security signal in response to the sensor 52 being removed from the input port provided on the item of merchandise 14.

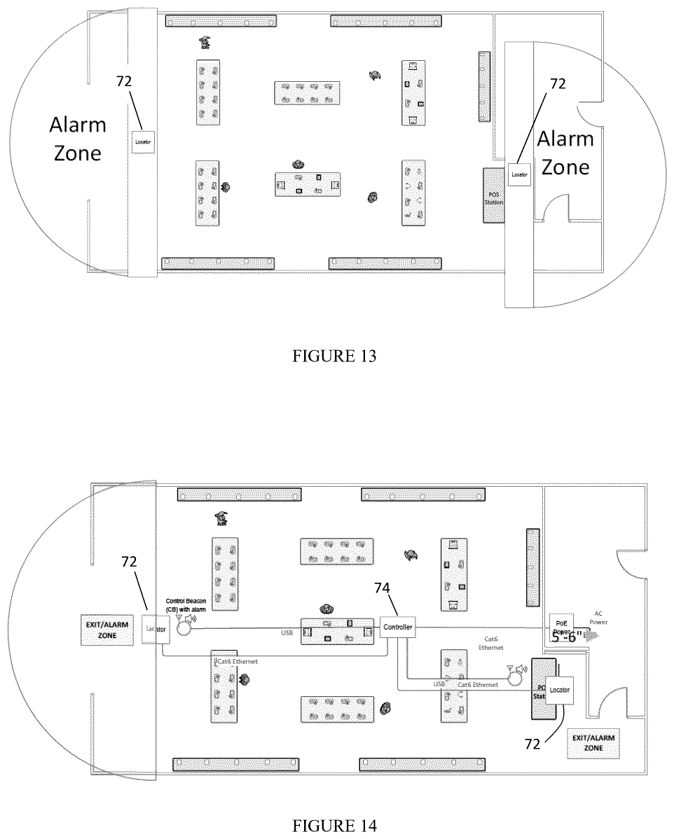

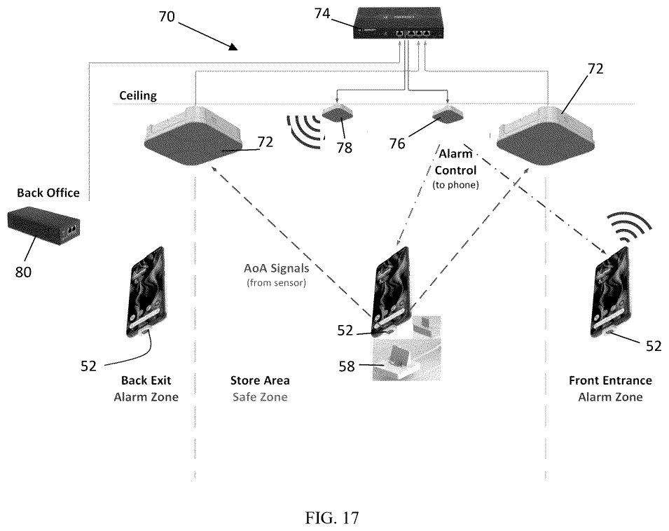

In additional embodiment shown in FIGS. 13-22, a security system utilizes Angle of Arrival (AoA) to locate and track devices within a retail environment. In some cases, this technology is enabled by Bluetooth BLE specifications and can provide much higher accuracy to indoor Real-Time Location Systems (RTLS) than existing RSSI approaches. AoA is already successful for asset and people tracking, but a retail security application has additional challenges. For example, retail security requires faster response to location changes, needs to catch tamper attempts, and will have a high density of sensors.

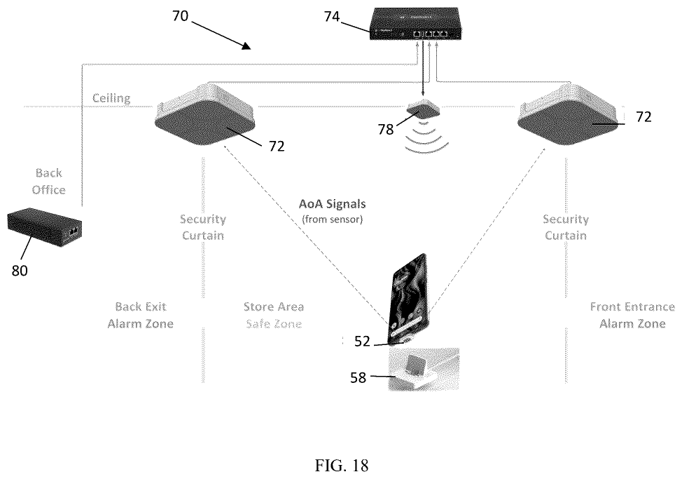

In general, the system includes a plurality of sensors 52 and a monitoring system 70 (see, e.g., FIG. 18). Each sensor 52 may be attached to or otherwise associated with an item of merchandise. In one example, the sensor 52 may be a tag. In the embodiment shown in FIG. 18, the sensor 52 may be a connector that is configured to be received in an input port of the item of merchandise that is configured to transmit and receive various power and security signals with the item. In one embodiment, the sensor 52 does not have its own power source, and may either receive power while positioned on a base 58 or stand or from the item of merchandise when lifted off of the base or stand.

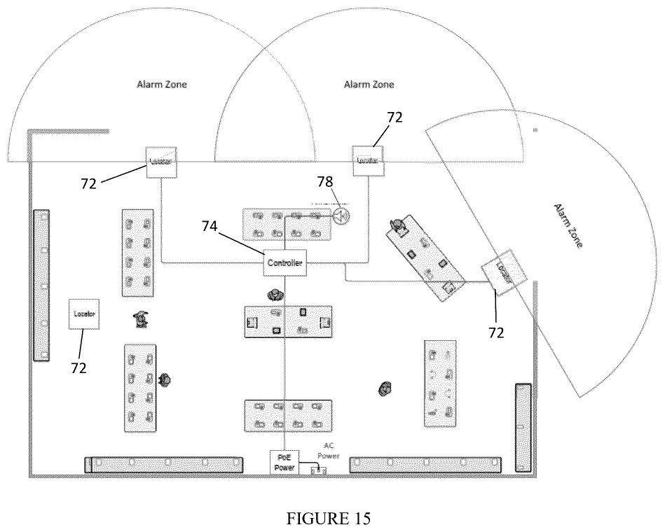

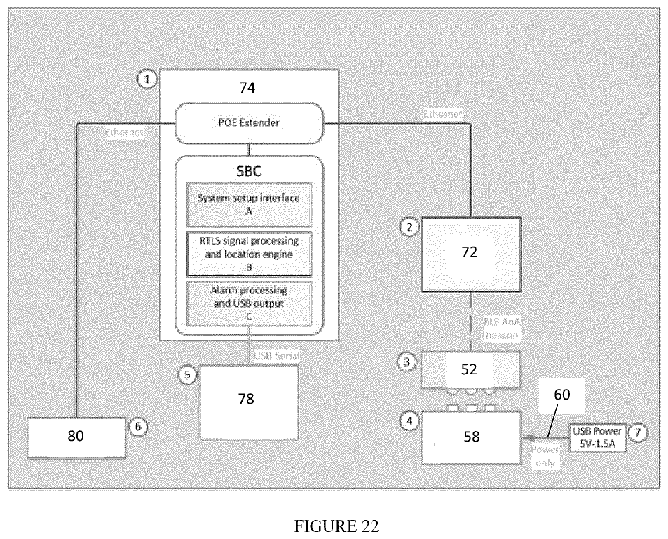

In some embodiments, the monitoring system 70 includes a plurality of locators 72 configured to communicate with the sensors 52 (see, e.g., FIG. 15). Each locator 72 may include an antenna array for detecting AoA signals. In the example where the sensors 52 are configured to function as a “beacon” and transmit signals (e.g., AoA messages), each locator 72 is configured to detect the signals using AoA. In some cases, the locator 72 may be positioned to detect signals from a predetermined direction to facilitate defining a particular zone (e.g., inclusion and/or exclusion zones). For example, FIG. 15 shows that the locators 72 may be configured to detect signals at different locations and angles. The monitoring system 70 may further include one or more controllers 74 configured to communicate with the locators 72, which may be used to determine whether to initiate a security signal. For instance, the controller 74 may include real-time location system (“RTLS”) processing to interpret the signals and determine a location of the sensor based on the AoA signals (see, e.g., FIG. 22). Each sensor 52 may be configured to adjust its beacon rates to enable larger scale installations of sensors. The controller 74 may be configured to command sensors 52 to speed up or slow down based on sensor status, location, and/or number of sensors moving in the store. In other embodiments, the beacon rates may be configured to be adjusted automatically by the sensors 52.

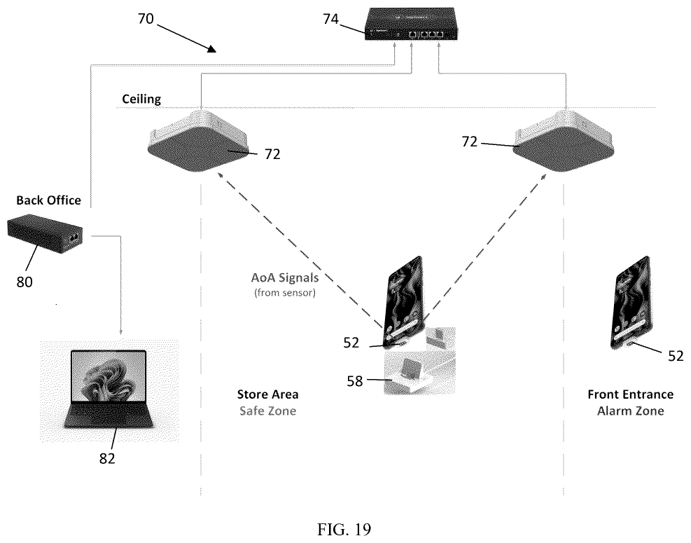

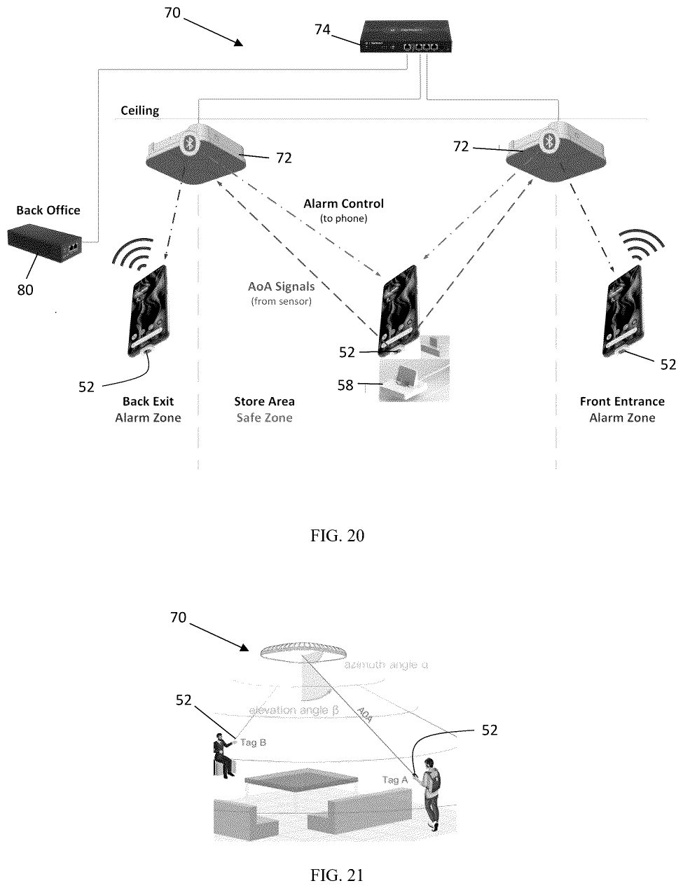

If the controller 74 determines to initiate a security signal, the controller may transmit a signal to the sensor 52 to generate the signal. The monitoring system 70 may utilize a control beacon 76 or other device to transmit such signals to the sensors 52. The control beacon may be configured to transmit other signals, such as commands to the item of merchandise and/or sensors 52 (e.g., to adjust the beacon rate of one or more sensors, initiate an alarm at the item, initiate an alarm at the sensor, etc.). The sensors 52 may in turn be configured to transmit a signal to its associated item of merchandise to generate a security signal and/or to disable the item (e.g., such that the item is inoperable). In other cases, the monitoring system 70 may include one or more annunciators 78 that are also configured to generate a security signal. Such annunciators 78 may be located at predetermined locations, such as the entrance or exit of a retail store. In still further embodiments, the monitoring system 70 may be configured to beacon or otherwise provide a signal directly to the item of merchandise to generate a security signal (see, e.g., FIG. 20). In some cases, one or more remote devices 82 (e.g., a laptop or other computing device) may be configured to communicate with the monitoring system to receive various information (e.g., alarming events) or to provide signals to control the monitoring system (e.g., to initiate a security signal) (see, e.g., FIG. 19).

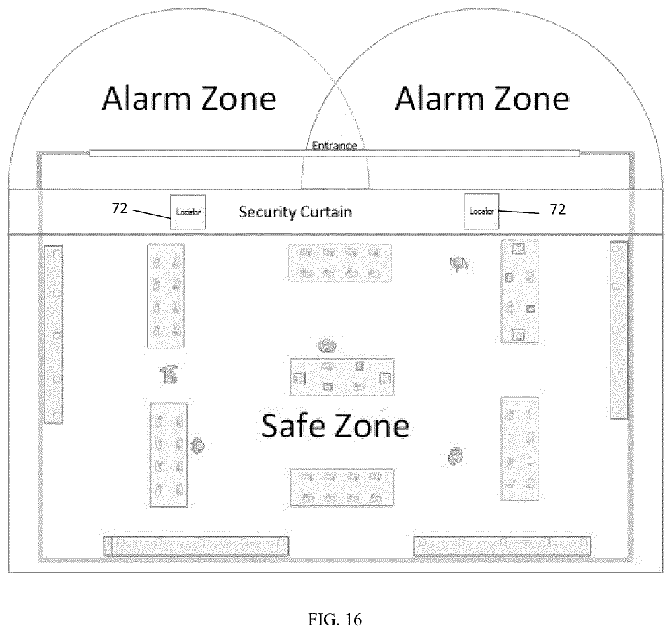

In one embodiment, the sensors 52 are configured to beacon the signals to locators 72 located on the ceiling of a retail store or other establishment. As noted above, AoA signals may be transmitted and detected, which may facilitate the creation of one or more zones between the sensors 52 and the monitoring system 70. In addition or alternatively, the AoA signals may create a “security curtain” at various locations in a retail store or other establishment, e.g., a curtain defined by signals being transmitted between the locators 72 and the sensors 52. For instance, FIG. 16 shows that a security curtain may be defined along a predefined area near an entrance of an establishment. Thus, a sensor 52 crossing the security curtain may initiate a security signal. In some embodiments, the security curtain extends vertically between the locators 72 and sensors 52 and may be desired width and length depending on the area to be protected.

Moreover, FIGS. 13-16 demonstrate that various zones may be created based on the communication between the sensors 52 and the monitoring system 70. Some zones may be alarm zones based on a predetermined proximity range or zone, such as at an entrance or exit of an establishment. If a sensor 52 enters the alarm zone, a security signal will be generated. Other zones may be considered “safe” whereby the sensors 52 will not cause an alarm as long as the sensor stays within the safe zone, e.g., the interior of a retail store such as a display area or checkout area. As illustrated, one or more zones may be utilized based on the number of locators 72 employed. For example, one locator 72 may be used per zone. In some cases, one or more alarm zones may be used which may overlap (see, e.g., FIG. 16). The size and/or configuration of the retail store or other establishment may affect the number of locators 72 needed. For instance, it may not be possible for a sensor 52 to be in all safe zones or for the sensor to have a good communication signal with all locators 72. Thus, adding locators 72 will increase the safe zones to cover the entire store or desired area. As noted above, AoA signals may be transmitted and detected, which may facilitate the creation of a “cone” of signals between the sensors 52 and the monitoring system 70 (see, e.g., FIG. 21). Thus, in some cases, the zones may be multi-dimensional thereby creating a more accurate means of determining the location of the sensors 52.

In some embodiments, the system is configured to avoid false alarms which can be very disruptive to the retail store. In one example, the system is configured to detect removal of the sensor 52 from the item of merchandise, when the sensor crosses a security curtain, when the sensor enters an alarm zone, and/or if the sensor is tampered, blocked, or otherwise unable to communicate with the monitoring system 70 (e.g., due to sensor degradation). In some cases, a security signal may cease as soon as the issue is resolved (e.g., the sensor 52 moves from an alarm zone back into a safe zone) or will time out after a predetermined time. Other activities that may be indicative of a security event are detecting movement of a sensor 52 while the sensor docked on a base 58 or stand. This may be indicative of a tamper attempt to power the sensor 52 with a battery pack and keep it in a docked mode (e.g., resulting in a slow beacon rate) and remove from store. Sensors 52 are not expected to move if powered from their stationary base 58 or stand. In one embodiment, no electronic key is required in the system, although a key could be used to control one or more components if needed (e.g., an electronic key for arming or disarming a sensor).

Another potential advantage of the system is case of installation and avoiding a software setup process, which can involve mapping the store and defining location, orientation and placement each locator 72, followed by further setup to identify special zones in software. For some installations, no software setup is required, such as where an alarm zone can be defined with a straight-line security curtain below the locator(s) 72 and/or the safe zone is within a predefined area. The setup process may include placing locator(s) 72 on the ceiling and orienting where the security curtain is needed, placing annunciator(s) 78 on the ceiling either near the locator(s) or in between, placing the controller 74 in the ceiling within a predefined distance of the annunciator (e.g., USB cable to annunciator). The installation process may also include locating the power supply 80 at an existing outlet, connecting power supply, controller 74, and locators 72, installing stands 58 within a predefined distance within a safe zone, and installing sensors 52 on items of merchandise. An internet connection is not required for installation or operation in some instances, which keeps the system isolated from the customer's network, thereby avoiding a customer's security issues and IT requirements.

In some embodiments, the system may be configured to detect various events and activities. For example, the initial installation of a sensor 52 with an item of merchandise may be detected. In some cases, this may cause the generation of a security signal, which may be temporary to alert store personnel and/or until communication is initiated with the monitoring system 70. Thus, the sensor 52 may know when it has been removed from the item or has been attached to a new item. Other activities that can be monitored are normal use activities (i.e., non-alarming events), such as a customer using an item of merchandise while it is exposed in the store, which may include hands partially covering the sensor 52 but not intentionally trying to block, the customer holding an item with one hand at the base partially covering the sensor and using the other hand to interact with the phone (hands both beneath and above sensor), and holding the item in any orientation to simulate using apps, taking photos, making call, inspecting case etc. while the user has his or her back to the locator 72. These types of normal use activities may not cause a security signal. Unintended misuse may also be tracked or correctable, such as a customer temporarily putting an item of merchandise in his or her pocket to test the size of the item. Thus, in some embodiments, the customer will have freedom to move around in safe zone(s) without any security signals being generated.

In some cases, any security system disclosed herein may incorporate one or more features of U.S. Pat. No. 8,878,673, entitled Systems and Methods for Protecting Retail Display Merchandise From Theft, and U.S. Pat. No. 9,437,088, entitled Systems and Methods for Protecting Retail Display Merchandise From Theft, and U.S. Pat. No. 11,361,635, entitled Merchandise Display Security Systems and Methods, the contents of each of which are incorporated by reference herein.

It should be noted that the operations executed by the sensors, monitoring devices, monitoring systems, and/or items of merchandise for any of the embodiments disclosed herein may be provided by a computer-readable medium, memory, or other storage medium. Many modifications and other embodiments of the invention will be readily apparent to one skilled in the art having the benefit of the teachings presented in the foregoing descriptions and the associated drawings. Therefore, it is understood and appreciated that the invention is not to be limited to the specific embodiments disclosed herein, and that modifications to the disclosed embodiments and other undisclosed embodiments are intended to be included within the scope of the appended claims.

That which is claimed is:

1. A security system configured for securing an item of merchandise from theft, the security system comprising:
a plurality of sensors, each sensor configured to be secured to an item of merchandise; and
a monitoring system configured to wirelessly communicate with each of the plurality of sensors,
wherein the monitoring system and the plurality of sensors are configured to communicate signals with one another to determine a location of each sensor based on an angle of arrival of the signals,
wherein the monitoring system and/or at least one of the plurality of sensors is configured to initiate a security signal based on the location of each sensor.

2. The security system of claim 1, wherein each of the plurality of sensors is configured to beacon the signals, and wherein the monitoring system is configured to detect the signals using angle of arrival.

3. The security system of claim 1, further comprising a plurality of bases, wherein each base is configured to removably support a respective sensor thereon and be coupled to a remote power source for providing power to the item of merchandise when the sensor is supported on the base.

4. The security system of claim 1, wherein the monitoring system and/or at least one of the sensors is configured to initiate a security signal when the distance between the monitoring system and at least one of the sensors is not within a predetermined proximity range.

5. The security system of claim 1, wherein the monitoring system and/or at least one of the plurality of sensors is configured to initiate a security signal when the distance between the monitoring system and at least one of the sensors is within a predetermined proximity range.

6. The security system of claim 1, wherein each sensor is configured to receive power from a respective item of merchandise.

7. The security system of claim 1, wherein each of the sensors and the monitoring system are configured to wirelessly communicate the signals via Bluetooth communication.

8. The security system of claim 1, wherein the sensor and the monitoring system are configured to be wirelessly paired to one another.

9. The security system of claim 1, wherein the monitoring system comprises at least one annunciator configured to generate the security signal.

10. The security system of claim 1, wherein the monitoring system comprises a plurality of locators configured to wirelessly communicate with each of the plurality of sensors and measure the angle of arrival of the signals.

11. The security system of claim 10, wherein the monitoring system comprises a controller configured to communicate with the plurality of locators and to determine the location of the plurality of sensors.

12. The security system of claim 11, wherein the controller is configured to determine whether to generate the security signal.

13. The security system of claim 12, wherein the controller is configured to send a signal to at least one of the plurality of sensors to generate the security signal.

14. The security system of claim 13, wherein each sensor is configured to send a signal to the item of merchandise to generate the security signal.

15. The security system of claim 13, wherein each sensor is configured to send a signal to the item of merchandise to disable the item of merchandise.

16. A method for securing an item of merchandise from theft, the method comprising:
wirelessly communicating signals between a monitoring system and a plurality of sensors, each sensor being secured to an item of merchandise;
determining a location of each sensor based on an angle of arrival of the signals; and
initiating a security signal at the monitoring system and/or at least one of the sensors based on the location of each sensor.

17. The method of claim 16, wherein initiating the security signal comprises generating the security signal with at least one of the sensors.

18. The method of claim 16, wherein initiating comprises initiating the security signal when the distance between the monitoring system and at least one of the sensors is within a predetermined proximity range.

19. The method of claim 16, wherein initiating comprises initiating the security signal when the distance between the monitoring system and at least one of the sensors is not within a predetermined proximity range.

20. The method of claim 16, wherein initiating the security signal comprises sending a signal to the item of merchandise to generate the security signal.
